(19) United States
(12) Patent Application Publication
(10) Pub. No.: US 2013/0153405 A1
(43) Pub. Date: Jun. 20, 2013

(54) APPARATUS AND METHODS FOR GENERATING HYDROGEN FROM WATER

(71) Applicant: Salvatore Benenati, Ocean, NJ (US)

(72) Inventor: Salvatore Benenati, Ocean, NJ (US)

(73) Assignee: Hydro-Magnetics, Inc., Ocean, NJ (US)

(21) Appl. No.: 13/517,757

(22) Filed: Jun. 14, 2012

Related U.S. Application Data
(60) Provisional application No. 61/520,713, filed on Jun. 14, 2011.

(51) Int. Cl. C01B 3/04

(52) U.S. Cl. CPC C01B 3/042
USPC 204/157.5; 204/273; 422/186.01

(57) ABSTRACT

Apparatus and methods are provided for generating hydrogen gas from water and, in particular, apparatus and methods for dissociating hydrogen and oxygen atoms from water molecules using a rotating magnetic field.

### CROSS-REFERENCE TO RELATED APPLICATION

This application claims priority to U.S. Provisional Patent Application Ser. No. 61/520,713, filed on Jun. 14, 2011, which is incorporated herein by reference.

### TECHNICAL FIELD

The field relates generally to apparatus and methods for generating hydrogen gas from water and, in particular, apparatus and methods for dissociating hydrogen and oxygen atoms from water molecules using a rotating magnetic field.

### BACKGROUND

Recently, there has been significant research with regard to the use of hydrogen gas as a renewable energy source. Hydrogen gas is considered to have great potential as an energy source for various systems such as hydrogen-fueled vehicles (e.g., cars, trucks, airplanes, etc.), generating electricity through fuel cells, and use in gas combustion systems.

There are various techniques for generating hydrogen gas from water. One method involves exposing water to intense radio waves to break the water molecules into the constituent components of hydrogen and oxygen. This process is not energy efficient, as the energy required to generate the radio waves (power supply for radio oscillators and amplifiers) is actually greater than the energy that is recoverable if the hydrogen and oxygen were combusted and the heat used to generate electricity to power the operation.

Another method for generating hydrogen gas from water involves electrolyzing water. The process of electrolyzing water involves the use of electricity to separate hydrogen and oxygen atoms from water molecules. Again, this process can be inefficient as the amount of electricity needed to electrolyze water to generate hydrogen can be excessive.

### SUMMARY

Exemplary embodiments of the invention generally include apparatus and method for generating hydrogen from water and, in particular, apparatus and methods for dissociating hydrogen and oxygen atoms from water molecules using a rotating magnetic field.

In one exemplary embodiment of the invention, an apparatus for generating hydrogen from water includes a container, a housing, and means for rotating the housing. The container holds water, wherein the water includes an electrolyte. The housing supports a plurality of magnets including at least a first magnet and a second magnet. A least a portion of the container is disposed within the housing with the first and second magnets disposed on inner side surfaces of the housing such that a magnetic field from the first magnet to the second magnet penetrates the portion of the container. The rotating means rotates the housing to rotate the plurality of magnets and cause dissociation of water within the container into hydrogen and oxygen gases due a rotating magnetic field rotating through the water within the container.

In another exemplary embodiment of the invention, a method for generating hydrogen includes filling water into a container, the water including an electrolyte, and generating a rotating magnetic field with flux lines rotating through at least a portion of the container to cause dissociation of water within the portion of the container into hydrogen and oxygen gases due to the rotating magnetic field rotating through the water within the container.

These and other exemplary embodiments, aspects and features of the present invention will become apparent from the following detailed description of exemplary embodiments thereof, which is to be read in connection with the accompanying drawings.

### BRIEF DESCRIPTION OF THE DRAWINGS

FIG. 1 is a schematic side-view of an apparatus for generating hydrogen gas from water according to an exemplary embodiment of the invention.

FIG. 2 is a schematic top-view of the apparatus of FIG. 1.

FIG. 3 is a schematic side-view of an apparatus for generating hydrogen gas from water according to another exemplary embodiment of the invention.

### DETAILED DESCRIPTION OF EXEMPLARY EMBODIMENTS

Exemplary embodiments will now be discussed in further detail with regard to apparatus and methods for generating hydrogen from water and, in particular, apparatus and methods for dissociating hydrogen and oxygen atoms from water molecules using a rotating magnetic field.

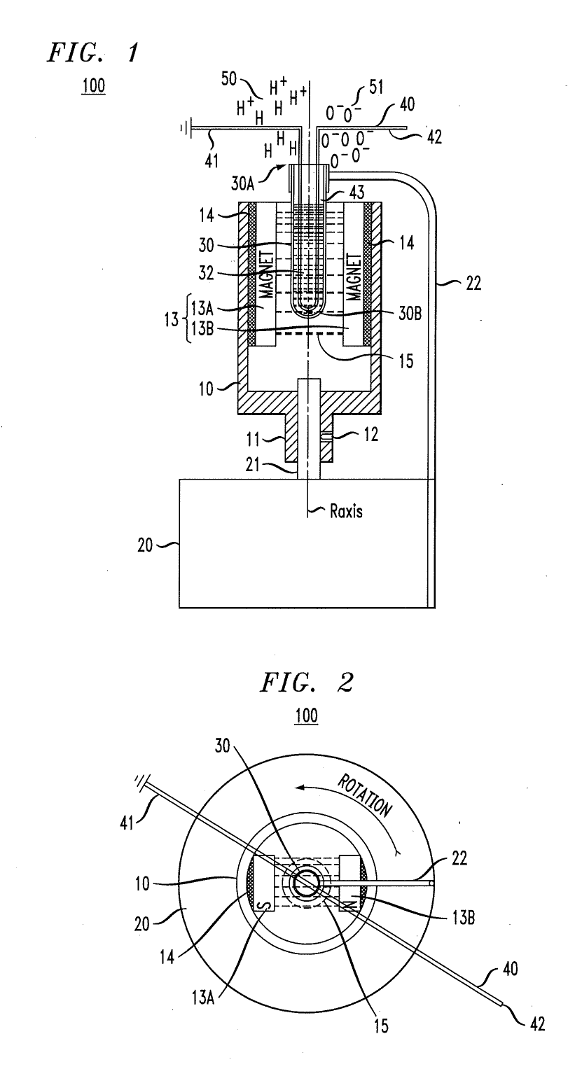

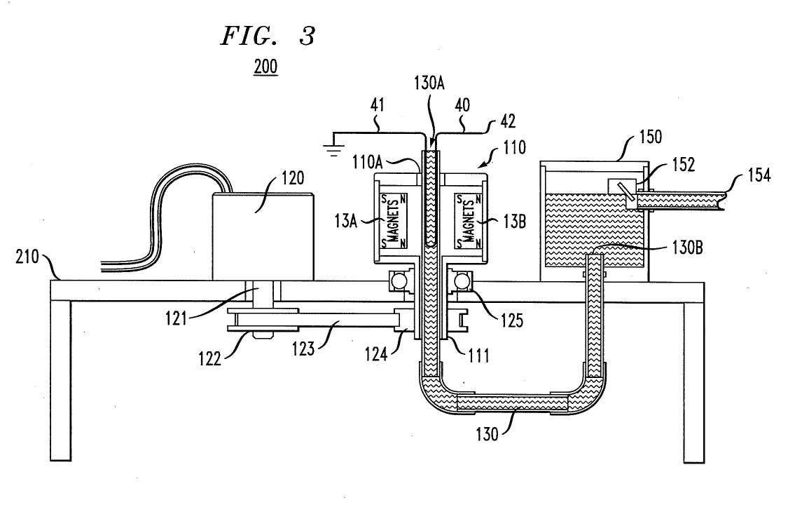

For example, FIGS. 1 and 2 schematically illustrate an apparatus for generating hydrogen gas from water according to an exemplary embodiment of the invention. In particular, FIG. 1 is a schematic side-view of an apparatus 100 for generating hydrogen gas from water and FIG. 2 FIG. 2 is a schematic top-view of the apparatus 100 of FIG. 1.

Referring to FIGS. 1 and 2, in general, the apparatus 100 comprises a housing 10, a rotating means 20 for rotating the housing 20, and a container 30 for holding water 32. The rotating means 20 is coupled to the housing 10 via a rotating shaft 22. The housing 10 comprises a collar 11 on one end thereof that insertably receives the rotating shaft 22. The collar 11 of the housing 10 is mechanically fastened to the rotating shaft 22 using a set screw 12, for example, although other suitable fastening mechanisms and techniques may be employed.

The rotating means 20 may be any suitable mechanical and/or electrical system that is configured to rotate the rotating shaft 22 about an axis of rotation Rₐₓᵢₛ. For instance, the rotating means 20 may be an electric motor having the rotating shaft 22 coupled thereto. In another exemplary embodiment, the rotating means 22 may be a pulley system that is mechanically rotated by mechanical means (e.g., such as a pulley and belt system connected to a drive shaft of an engine, a windmill, etc.) or electric means (e.g., electric motor).

As depicted in FIGS. 1 and 2, the housing 10 may be cylindrical shaped, although the housing 10 may have other geometric shapes (e.g., rectangular). In one preferred embodiment, the housing 10 is made of a ferrous metallic material. The housing 10 further comprises a plurality of magnets 13 that are securely fastened to an inner surface of the housing 10 via fastening means 14. The fastening means 14 may comprise an adhesive material such as an epoxy adhesive. In the exemplary embodiment of FIGS. 1 and 2, the plurality of magnets 13 include a first magnet 13A and a second magnet 13B, which are mounted to the inner surface of the housing 10 facing opposite to each other. The magnets 13A and 13B have facing polar surfaces of opposing polarity. For instance, the first magnet 13A has a south (S) pole surface facing a north (N) pole surface of the second magnet 13B, with magnetic flux lines 15 generated between the magnets 13A and 13B.

It is to be understood that the number of magnets and the arrangement of magnets depicted in FIGS. 1 and 2 is merely exemplary, and not limiting to the scope of the invention. The housing 10 can contain 2 or more magnets that are radially disposed at equal or unequal intervals around the inner surface of the housing 10. Any number of magnets and arrangement of magnets along the inner surface of the housing 10 can be implemented as long as a sufficient amount of the resulting magnetic flux lines that flow from one or more magnets to one or more other magnets pass through and penetrate the water 32 within the container 30 as the housing 10 rotates. Moreover, each of the magnets 13 may be any type of permanent magnet and/or electro-magnet, for example.

The container 30 is preferably made of an inert non-metallic material or non-magnetic material (such as glass or ceramic). In the exemplary embodiment of FIGS. 1 and 2, the container 30 is depicted as a tube with an open end 30A and a closed end 30B, which is fixedly positioned (suspended) at the center of the housing 10 by a holding bracket 22. The container 30 is positioned within the housing 10, wherein at least a portion of the container 30 is disposed within the housing in proximity to the magnets 13 such that a magnetic field from the first magnet 13A to the second magnet 13B passes through the water 32 in the container 30.

The apparatus 100 further comprises an at least one optional metallic (non-insulated) wire 40 having a first end 41 and a second end 42, wherein portion 43 of the metallic wire 40 is inserted within the water 32 in the container 30. The first end 41 is grounded and disposed outside the container 30, and the second end 42 is floating and disposed outside the container 30. In one exemplary embodiment as shown in FIG. 1, the portion 43 of the metallic wire inserted within the water 32 is loop-shaped. In other embodiments, the portion 43 of the metallic wire inserted within the water can be coil-shaped. In yet other exemplary embodiments of the invention, two or more metallic wires can be employed.

In one exemplary mode of operation of the apparatus of FIGS. 1 and 2, the container 30 is filled with water 32. In a preferred embodiment, the water 32 comprises an electrolyte that increases the conductivity of the water 32. The electrolyte can be any suitable substance that dissociates into ions when dissolved in water and thus forms a conductor of electricity within the water. For instance, the electrolyte may be a salt, such as table salt (NaCl). By way of example, the water 32 my contain table salt in an amount of about 2 grams of salt per deciliter ( 1/10 of a liter) of water.

For ease of explanation, the container 30 is shown in FIG. 1 as a manually filled tube. In other embodiments (such as discussed below with reference to FIG. 3), the apparatus and container may be configured such an operation of filling and re-filling the container is automated.

Next, the rotating means 20 is (e.g., motor) is activated causing the rotating shaft 21 to rotate, thereby causing the housing 10 to rotate about the axis of rotation Rₐₓᵢₛ. While the housing 10 with the magnets 13 rotates, a rotating magnetic field is generated with flux lines rotating through at least a portion of the container 30, which causes dissociation of water 32 within the container 30 into hydrogen gas 50 and oxygen gas 51 due to the magnetic field rotating through the water 32. Experiments have indicated that the dissociation of water occurs when the housing 10 is rotated in a range of about 100 RPM (rotations per minute) to about 50,000 RPM or greater, wherein the dissociation of hydrogen and oxygen gases increases with increased speed of rotation.

The open end 30A of the container 30 serves as a gas outlet port from which the hydrogen gas 50 and oxygen gas 51 are emitted as they separate and come to the surface of the water 32 in the container 30. The hydrogen and oxygen gases 50 and 51 that are emitted from the outlet 30A can be separated and stored using techniques that are well known in the art. For example, the since hydrogen atom are positively charged and oxygen atoms are negatively charged, the hydrogen and oxygen atoms (ions) can be repelled or attracted using magnets or electrodes to cause the different gases to flow in directions towards separate gas collection channels of a gas collection device coupled to the output of the container 30.

The optional metallic (non-insulated) wire 40 can be employed to aid in the dissociation of water molecules into constituent hydrogen and oxygen atoms in several ways. For example, the time varying rotating magnetic field that is generated by rotating the housing intersects the wire 20, causing an alternating current/electric field to be generated in the water 32. This causes the wire 40 to become hot and heat up the water 32 in the container. The heating of the water (thermal energy) is believed to aid in the dissociation of water molecules into hydrogen and oxygen gases. Furthermore, the electric fields generated on the wire 40 are believed to electrolyze the water, thereby further aiding in the dissociation of water molecules into hydrogen and oxygen gases.

FIG. 3 is a schematic side-view of an apparatus 200 for generating hydrogen gas from water according to another exemplary embodiment of the invention. In general, the apparatus 200 of FIG. 3 comprises a reactor housing 110 (comprising a plurality of magnets 13A, 13B), mounting unit 201, a housing rotation system comprising a motor 120, rotating shaft 121, first pulley 122, belt 123, a second pulley 124, and bearing device 125 for rotatably mounting the reactor housing 110 to the mounting unit 210. The housing 110 (which is similar in function to the housing 10 of FIG. 1) has an elongated hollow collar 111 that is fixedly connected to the second pulley 124 and rotatably connected to the bearing unit 125.

The housing rotation system operates as follows. The motor 120 rotates the shaft 121, which is fixedly connected to the first pulley 122. The first pulley 122 is connected to the second pulley 124 via the flexible belt 123. As the first pulley 122 is rotated by the motor 120, the second pulley 124 is rotated by the belt 123 being rotated by the first pulley 122. AS the second pulley 124 rotates, the housing collar 111 rotates, thus causing the housing 110 to rotate. The bearing device 125 is configured using a known structure to enable the housing 110 to be rotatably connected to the mounting unit 210.

The apparatus 200 further comprises a container 130 having an outlet port 130A and an inlet port 130B, a water reservoir 150, a water level control device 152 and a water supply pipe 154. In the exemplary embodiment of FIG. 3, the container 130 comprises a pipe having a first end portion and a second end portion, wherein the first end portion extends up though the hollow collar 111, through the housing 100 and out through an aperture 110A formed in a top side of the housing 110, and wherein the second end portion is disposed within the reservoir 150. The inlet port 130B of the container 130 receives water from the reservoir 150 and the outlet port 130A for emitting hydrogen and oxygen gases that are generated as a result of dissociation of water within the portion of the container 130 in the housing 110 that is subjected to the rotating magnetic field generated as the housing 110 is rotated (similar to that as discussed above).

The water level in the end portion of the container 130 within the housing 110 is maintained at a same water level as the water in the reservoir 150 by operation of gravity. The water in the reservoir is maintained at a desired level by water supplied by the supply pipe 154. The water level control device 152 (e.g., float and valve mechanism) maintains the water level in the reservoir 150 at a desired level by allowing water to controllably flow into the reservoir 150 from the supply pipe 154 when the water level in the reservoir 150 drops below the desired level.

The apparatus 200 of FIG. 3 operates in a similar manner as the apparatus 100 discussed above with reference to FIGS. 1 and 2 with regard to disassociation of water molecules into hydrogen and oxygen by the rotating magnetic field generated within the housing and the thermal energy and water electrolyzing action generated by the optional wire 40. Experiments with apparatus constructed in accordance with the exemplary embodiments described herein have shown that there is no appreciable torque requirement other than what is required to rotate the housing itself, requiring substantially lower power requirements to generate hydrogen, as compared to conventional methods. The efficiency and magnitude of dissociation of water molecules into the constituent components of hydrogen and oxygen can be optimized by varying the type and concentration of electrolyte in the water, by varying the magnetic field strength (Gauss) of the magnets, and/or by varying the speed of rotation (RPM) of the housing.

Although exemplary embodiments of the present invention have been described herein with reference to the accompanying figures, it is to be understood that the invention is not limited to those precise embodiments, and that various other changes and modifications may be made therein by one skilled in the art without departing from the scope of the appended claims.

What is claimed is:

1. An apparatus, comprising:
a container for holding water, the water comprising an electrolyte;
a housing for supporting a plurality of magnets comprising at least a first magnet and a second magnet, wherein at least a portion of the container is disposed within the housing with the first and second magnets disposed on inner side surfaces of the housing such that a magnetic field from the first magnet to the second magnet penetrates said portion of the container;
means for rotating the housing to rotate the plurality of magnets and cause dissociation of water within the container into hydrogen and oxygen gases due a rotating magnetic field rotating through the water within the container.

2. The apparatus of claim 1, wherein the first and second magnets are a type of permanent magnet or an electro-magnet.

3. The apparatus of claim 1, wherein the rotating means rotates the housing in a range of about 100 RPM (rotations per minute) to about 50,000 RPM.

4. The apparatus of claim 1, wherein the rotating means comprises an electric motor, and a shaft fixedly connected to the housing and the electric motor.

5. The apparatus of claim 1, wherein the rotating means comprises a pulley and belt system attached to a mechanical or electrical rotating device, wherein the housing is connected to at least one pulley.

6. The apparatus of claim 1, further comprising at least one metallic wire having a first and second end, wherein portion of the metallic wire is inserted within the water in the container, wherein the first end is grounded and disposed outside the container, and wherein the second end is floating and disposed outside the container.

7. The apparatus of claim 6, wherein the portion of the metallic wire inserted within the water is loop-shaped.

8. The apparatus of claim 1, wherein the electrolyte comprises a salt.

9. The apparatus of claim 8, wherein the salt is table salt.

10. The apparatus of claim 1, wherein the container is made of a non-metallic or non-magnetic material.

11. The apparatus of claim 1, wherein the housing is made of a ferrous metallic material.

12. The apparatus of claim 1, wherein the container comprises an inlet port for receiving water and an outlet port for outputting hydrogen and oxygen gas generated by dissociation of water in the container.

13. The apparatus of claim 1, further comprising a reservoir tank for holding the water, wherein the container comprises a pipe having a first end portion that extends though the housing and a second end portion that is disposed within the reservoir.

14. The apparatus of claim 13, wherein a water level of the water in the first end portion of the pipe is level with a water level in the reservoir.

15. The apparatus of claim 14, wherein the reservoir comprises an inlet for insertably receiving a water supply pipe that supplies water to the reservoir, and further comprising water level control device that maintains the water level in the reservoir at a desired level.

16. A method for generating hydrogen, comprising;
filling water into a container, the water comprising an electrolyte; and
generating a rotating magnetic field with flux lines rotating through at least a portion of the container to cause dissociation of water within the portion of the container into hydrogen and oxygen gases due to the rotating magnetic field rotating through the water within the container.

17. The method of claim 14, wherein generating a rotating magnetic field comprises:
placing at least a first magnet and second magnet in proximity to a portion of the container to generate magnetic flux lines that pass through said portion of the container from the first magnet to the second magnet; and
rotating the first and second magnets around the container so that the magnetic flux lines that penetrate said portion of the container rotate about an axis of rotation passing through the water within the container.

18. The method of claim 17, wherein the first and second magnets are rotated around the container in a range of about 100 RPM (rotations per minute) to about 50,000 RPM.

19. The method of claim 17, wherein rotating the first and second magnets around the container comprises:
attaching the first and second magnetics to an inner surface of a housing;
placing the container within the housing with the first and second magnetics in proximity to sides of container; and
rotating the housing about the axis of rotation.

20. The method of claim 16, wherein the electrolyte comprises a salt.
